(19) United States
(12) Patent Application Publication
(10) Pub. No.: US 2017/0124107 A1
(43) Pub. Date: May 4, 2017

(54) DATA DEDUPLICATION STORAGE SYSTEM AND PROCESS

(71) Applicant: StoreReduce, Sunnyvale, CA (US)

(72) Inventor: Mark Alexander Hugh Emberson, Glebe (AU)

(73) Assignee: StoreReduce, Sunnyvale, CA (US)

(21) Appl. No.: 15/298,897

(22) Filed: Oct. 20, 2016

Related U.S. Application Data
(63) Continuation-in-part of application No. 62/249,885, filed on Nov. 2, 2015.
Application No. 62/249,885 is a continuation-in-part of application No. 62/339,090, filed on May 20, 2016.
Application No. 62/339,090 is a continuation-in-part of application No. 62/373,328, filed on Aug. 10, 2016.

(51) Int. Cl. G06F 17/30

(52) U.S. Cl. CPC G06F 17/30156; G06F 17/30097

(57) ABSTRACT

A data deduplication storage system and process is disclosed. In one implementation deduplication file storage system is added to an existing file storage system by receiving first files via a network from a remotely disposed computing device, dividing the files into data objects, creating hash values for the data objects, and store the data objects on more remotely disposed storage systems at network location addresses. Records of a storage table disposed on the intermediate device or a secondary remote storage system are stored for the data objects containing the hash values and corresponding network location addresses. When another of the files including one or more second data objects are received, a determination is made if the second data objects were previously stored on remotely disposed storage systems by comparing hash values for the second data object against hash values stored in records of the storage table.

### PRIORITY AND RELATED APPLICATIONS

This application claims the benefit of U.S. provisional application No. 62/249,885, filed Nov. 2, 2015; U.S. provisional application No. 62/373,328, filed Aug. 10, 2016; and U.S. provisional application No. 62/339,090, filed May 20, 2016; the contents of which are hereby incorporated by reference.

### TECHNICAL FIELD

These claimed embodiments relate to a method for reducing storage of data using deduplication and more particularly to using an intermediary data deduplication device to reduce storage of data objects via a network.

### BACKGROUND OF THE INVENTION

A data duplication storage system using an intermediary networked device to store data objects on a remotely located object storage device(s) is disclosed.

Deduplication is a specialized data compression technique for eliminating duplicate copies of repeating data. Deduplication of data is typically done to decrease the cost of storage of the data using a specially configured storage device having a deduplication engine internally connected directly to a storage drive.

The deduplication engine within the storage device receives data from an external device. The deduplication engine creates a hash from the received data which is stored in a table. The table is scanned to determine if an identical hash was previously stored in the table. If it was not, the received data is stored on the internal storage drive, and a location pointer for the received data is stored in an entry within the table along with hash of the received data. When a duplication of the received data is detected, an entry is stored in the table containing the hash and an index pointing to the location where the duplicated file is stored.

This system has the deduplication engine directly coupled to an internal storage drive to maintain low latency and fast storage of the hash table. However, the data is stored in additional specialized storage devices.

### SUMMARY OF THE INVENTION

In one implementation a method is disclosed to add a deduplication file storage system to an existing file storage system. In the method a processor executes set of instructions stored in a memory device of an intermediate computing system. The set of instructions when executed by the processor receives files via a network from a remotely disposed computing device, and divides the files into one or more data objects. Hash values are created for the data objects. The data objects are stored on remotely disposed storage systems at location addresses. The hash values and corresponding location addresses are stored in records of a storage table disposed on the intermediate device or a secondary remote storage system for each of the data objects. The name of the file and a list of the location addresses for the file's constituent data objects are stored in a file table disposed on the intermediate device. Another of the files is received from the networked computing device, and divided into a second set of one or more data objects. For each data object in the second set a determination is made if that data object was previously stored on the remotely disposed storage systems by comparing hash values for the second data object against hash values stored in the records of the storage table. If the second data object was previously stored, then its location address is recorded in a list. If the second data object was not previously stored, then the second data object is stored in the remotely disposed storage system at a location address. The hash and location address are stored in records in the storage table. The name of the second file and the list of location addresses is then stored in the file table.

In another implementation, an intermediate processing device to reduce duplication of the storage of one or more files is disclosed. The processing device includes circuitry to receive files via a network from a remotely located computing device, and circuitry to partition the received files into data objects. Circuitry is included to create hash values for the data objects and store the data objects on remotely located storage systems at one or more location addresses. Circuitry is included to store in records of a first storage table, for each of the data objects, the hash values and corresponding location addresses. Circuitry stores in records of a second storage table, a file name for the received files and the location addresses where the data objects that are included in one of the received files are stored. Circuitry determines, in response to a receipt from a networked computing device of one of additional files that include second data objects, if the second data objects are identical to data objects previously stored on the remotely disposed storage systems by comparing hash values for the second data objects against hash values stored in records of the storage table, and circuitry stores in records of a storage table for each of the received second data objects if the second data objects are identical to data objects previously stored on the remotely disposed storage systems, the hash values and a corresponding location address of the received second data objects, without storing on the remotely disposed storage systems the received second data objects identical to the previously stored data objects.

In addition, a computer readable storage medium comprising instructions for execution by a processor is disclosed. The computer readable storage medium includes instructions to receive files via a network from a remotely disposed computing device, instructions to partition the received files into data objects, instructions to create hash values for the data objects, and instructions to store the data objects on the remotely disposed storage systems at the location addresses. Instructions are included to store in records of a storage table, for each of the data objects, the hash values and corresponding location addresses, and instructions to store in records of a second storage table, a file name for at least one of the received files and the location addresses where the data objects that are included in one of the received files are stored. Instructions are provided to determine, in response to a receipt from a networked computing device of one of the additional files that include the second data objects, if the second data objects are identical to the data objects previously stored on the remotely disposed storage systems by comparing hash values for the second data objects against hash values stored in records of the storage table. The storage media further includes instructions to store in records of a storage table for each of the received second data objects if the second data objects are identical to data objects previously stored on the remotely disposed storage systems, the hash values and a corresponding location addresses of the received second data objects, without storing on the more remotely disposed storage systems the received second data objects identical to the previously stored data objects, and instructions to store in records of the second storage table, an additional file name for at least one of the received additional files and the location addresses where the data objects that are included in the at least one additional received file are stored, wherein at least one location addresses where at least one of the data objects that are included in the additional received file are stored matches at least one of the location addresses where the data objects that are included in the received files are stored.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a deduplication storage system using an intermediary networked device to perform deduplication;

FIG. 2 is a simplified schematic and flow diagram of a storage system in which a client application on a client device communicates through an application program interface (API) directly connected to a cloud object store;

FIG. 3 is a simplified schematic diagram and flow diagram of a deduplication storage system in which a client application communicates via a network to an application program interface (API_{[SS1]}) at an intermediary computing device which performs deduplication, and then stores data via a network to a cloud object store.

FIG. 4 is a simplified schematic diagram of an intermediary computing device shown in FIG. 3.

FIG. 5 is a flow chart of a process for storing and deduplicating data executed by the intermediary computing device shown in FIG. 3;

FIG. 6 is a flow diagram illustrating the process for storing and deduplicating data;

FIG. 7 is a flow diagram illustrating the process for storing and deduplicating data executed on the client device of FIG. 3.

FIG. 8 is a data diagram illustrating how data is partitioned into blocks for storage.

FIG. 9 is a data diagram illustrating how the partitioned data blocks are stored in memory.

FIG. 10 is a data diagram illustrating a relation between a hash and the data blocks that are stored in memory.

FIG. 11 is a data diagram illustrating the file or object table which maps file or object names to the location addresses where the files are stored.

### DETAILED DESCRIPTION

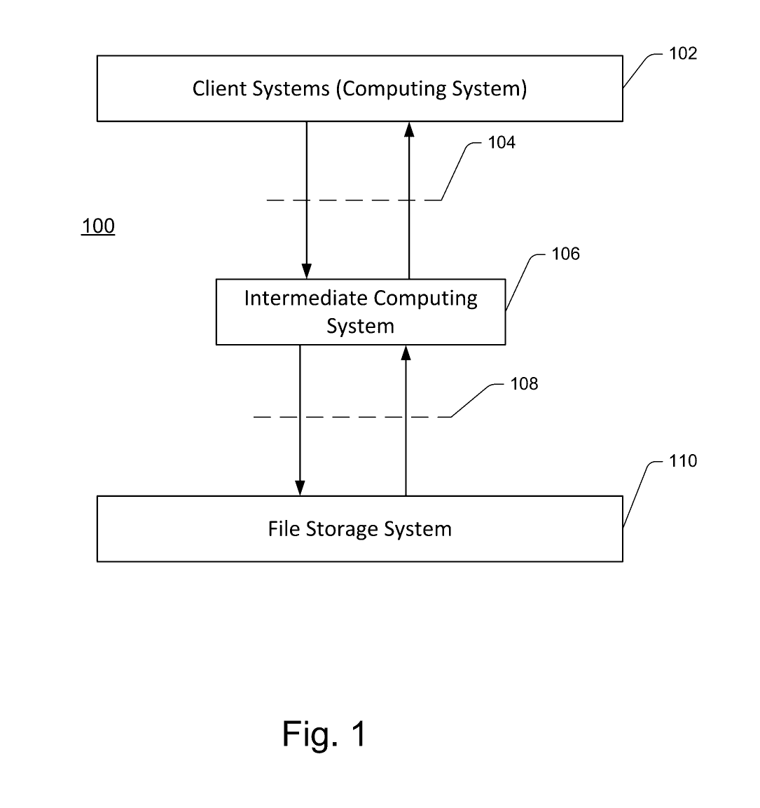

Referring to FIG. 1, there is shown a deduplication storage system 100. Storage system 100 includes a client system 102, coupled via network 104 to Intermediate Computing system 106. Intermediate computing system 106 is coupled via network 108 to remotely located File Storage system 110.

Storage system 100 transmits data objects to intermediate computing system 106 via network 104. Intermediate computing system 106 includes a process for storing the received data objects on file storage system 100 to reduce duplication of the data objects when stored on file system 100.

Storage system 100 transmits requests via network 104 to intermediate computing system 106 for data store on file storage system 110. Intermediate computing system responds to the requests by obtaining the deduplicated data on file system 110, and transmits the obtained data to client system 100.

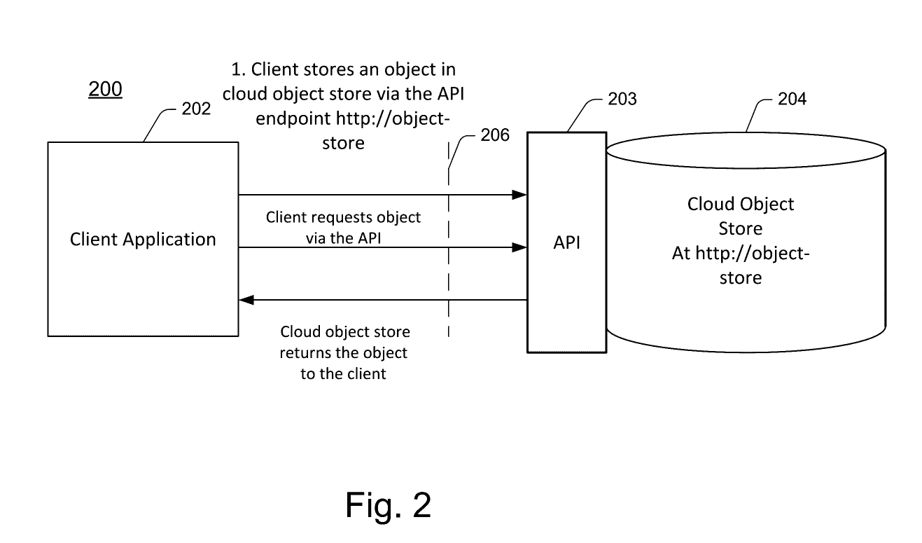

Referring to FIG. 2, a storage system 200 that includes a client application 202 on a client device 204 that communicates via a network 206 through an application program interface (API) 211 directly connected to a cloud object store 210.

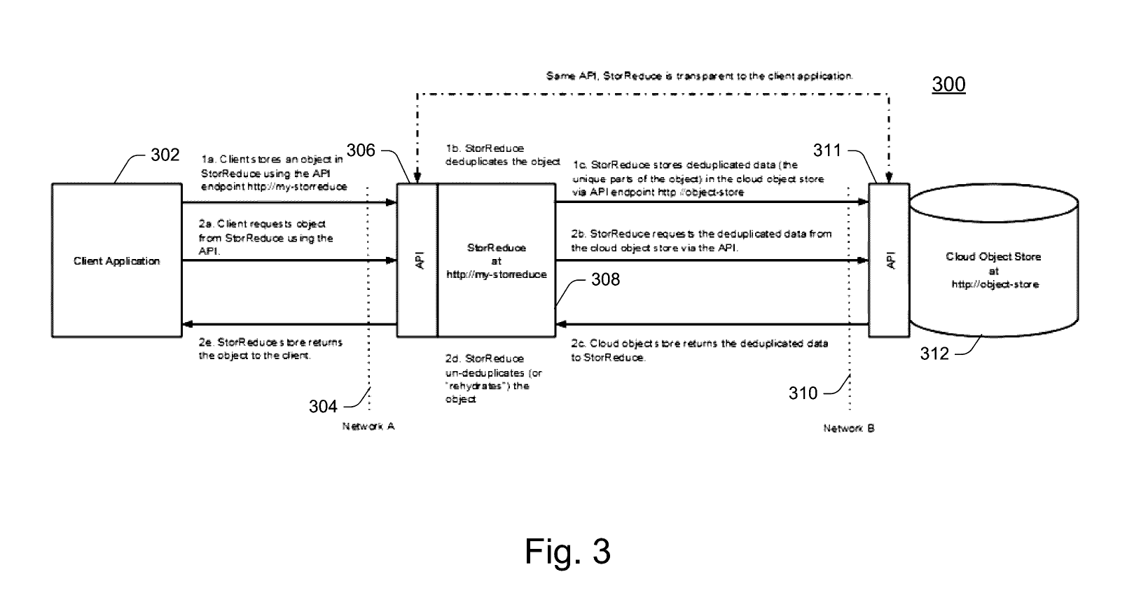

Referring to FIG. 3, there is shown a deduplication storage system 300 including a client application 302 communicates data via a network 304 to an application program interface (API) 311 at an intermediary computing device 308. The data is deduplicated on intermediary computing device 308 and then the unique data is stored via a network 310 and API 311 (API 211 in FIG. 2) on a remotely disposed computing device 312 such as a cloud object store system that may typically be administered by an object store service.

Exemplary Networks 304 and 310 include, but is not limited to, an Ethernet Local Area Network, a Wide Area Network, an Internet Wireless Local Area Network, an 802.11g standard network, a WiFi network, a Wireless Wide Area Network running protocols such as GSM, WiMAX, or LTE.

Examples of the intermediary computing device 308, includes, but is not limited to, a Physical Server, a personal computing device, a Virtual Server, a Virtual Private Server, a Network Appliance, and a Router/Firewall.

Exemplary remotely disposed computing device 312 may include, but is not limited to, a Network Fileserver, an Object Store, an Object Store Service, a Network Attached device, a Web server with or without WebDAV.

Examples of the cloud object store include, but are not limited to, OpenStack Swift, IBM Cloud Object Storage and Cloudian HyperStore. Examples of the object store service include, but are not limited to, Amazon® S3, Microsoft® Azure Blob Service and Google® Cloud Storage.

During operation Client application 302 transmits a file via network 304 for storage by providing an API endpoint (such as http://my-storereduce.com) 306 corresponding to a network address of the intermediary device 308. The intermediary device 308 then deduplicates the file as described herein. The intermediary device 308 then stores the deduplicated data on the remotely disposed computing device 312 via API endpoint 311. In one exemplary implementation the API endpoint 306 on the intermediary device is virtually identical to the API endpoint 311 on the remotely disposed computing device 312.

If client application need to retrieve a stored data file, client application 302 transmits a request for the file to the API endpoint 306. The intermediary device 308 responds to the request by requesting the deduplicated data from remotely disposed computing device 312 via API endpoint 311. The cloud object store 312 and API endpoint 311 accommodate the request by returning the deduplicated data to the intermediate device 308, that is then un-deduplicated by the intermediate device 308. The intermediate device 308 via API 306 returns the file to client application 302.

In one implementation, device 308 and a cloud object store is present on device 312 that present the same API to the network. In one implementation the client application 302 uses the same set of operations for storing and retrieving objects. Preferable the intermediate device 307 is almost transparent to the client application. The client application 302 does not need to know that the intermediate API 311 and intermediate device 306 are present. When migrating from a system without the intermediate processing device 308 (as shown in FIG. 2) to a system with the intermediate processing device, the only change for the client application 302 is that location of the endpoint of where it stores data has changed in its configuration (e.g., from http://objectstore to http://mystorreduce). The location of the intermediate processing device can be physically close to the client application to reduce the amount of data crossing Network 310 which can be a low bandwidth Wide Area Network.

### Example Computing Device Architecture

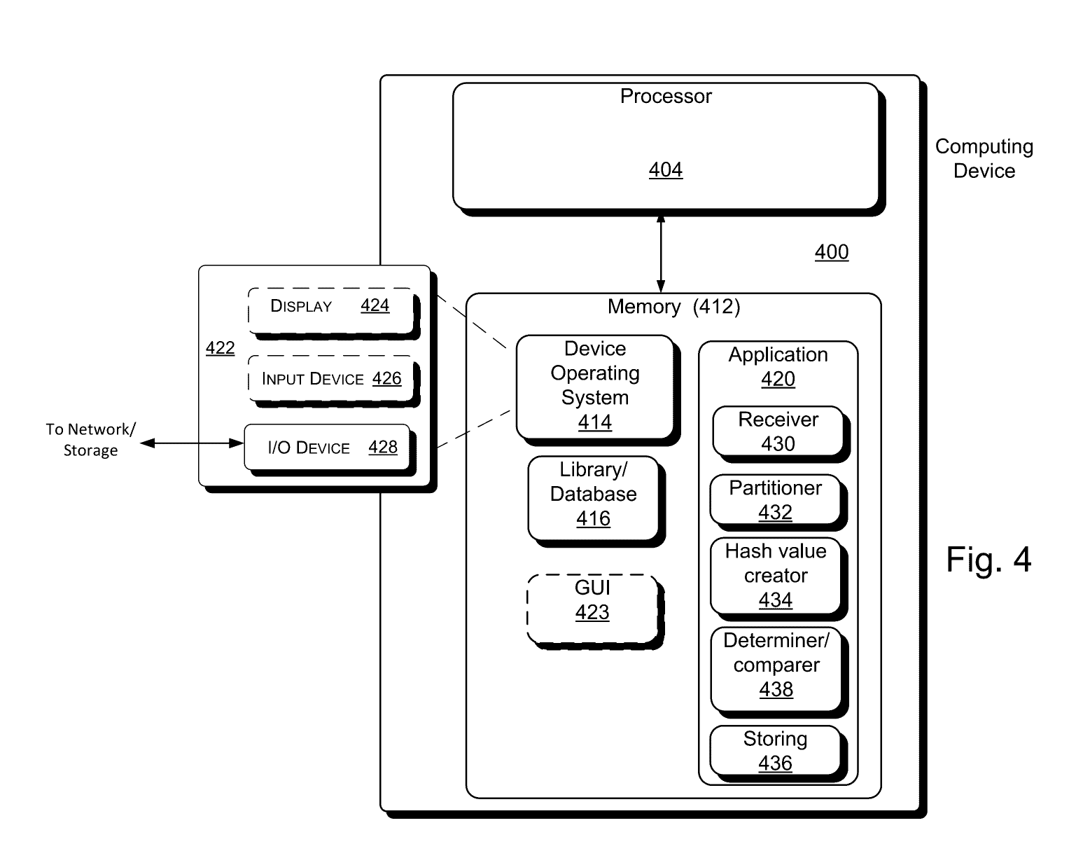

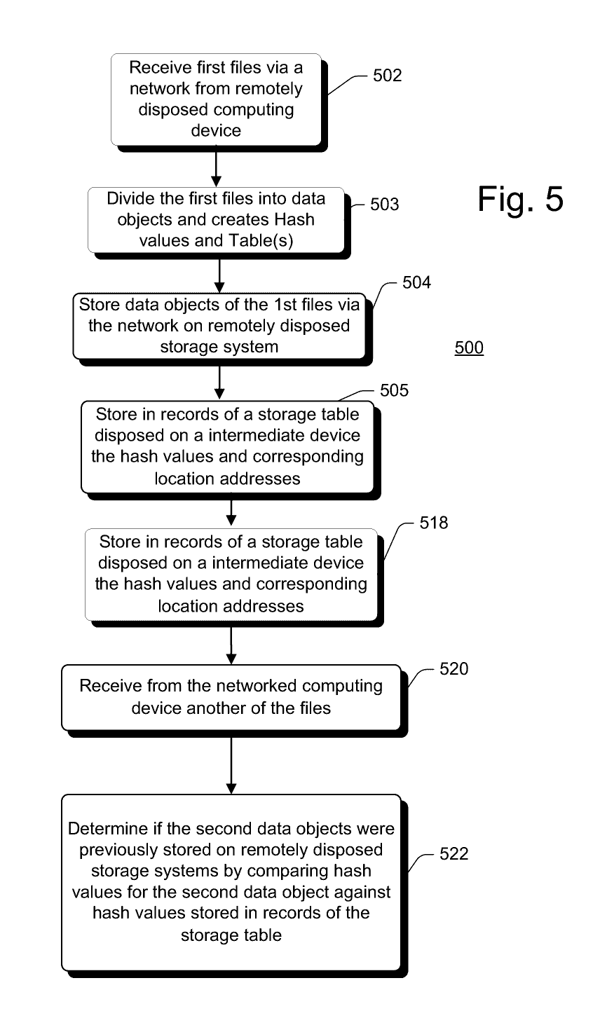

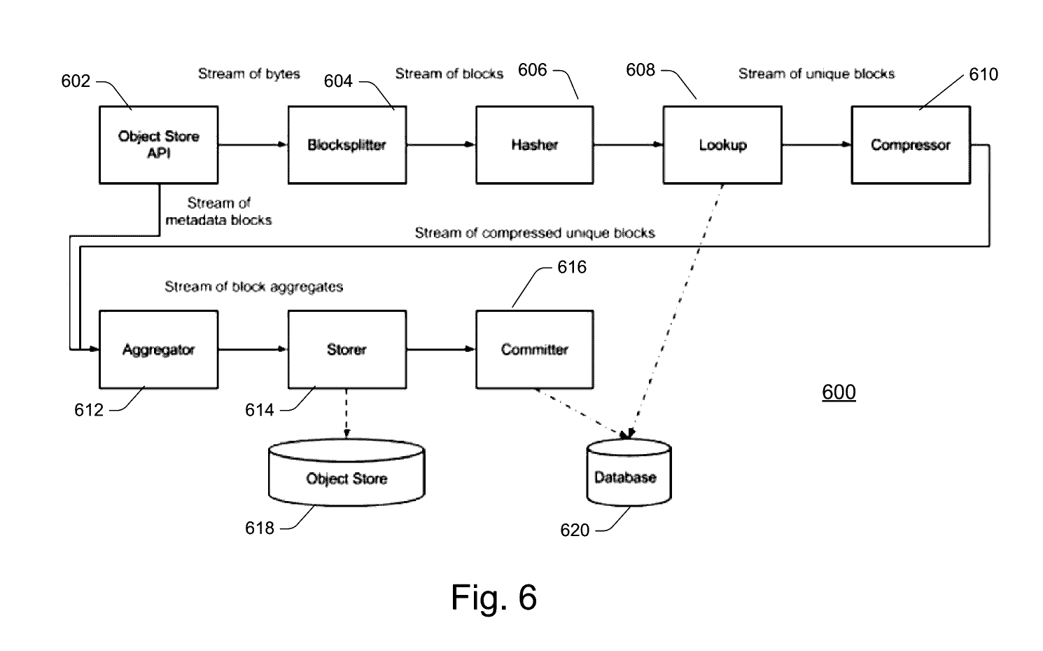

In FIG. 4 are illustrated selected modules in computing device 400 using processes 500 and 600 shown in FIGS. 5-6 respectively to store and retrieve deduplicated data objects. Computing device 400 (such as intermediary computing device 308 shown in FIG. 3) includes a processing device 404 and memory 412. Computing device 400 may include one or more microprocessors, microcontrollers or any such devices for accessing memory 412 (also referred to as a non-transitory media) and hardware 422. Computing device 400 has processing capabilities and memory suitable to store and execute computer-executable instructions.

Computing device 400 executes instruction stored in memory 412, and in response thereto, processes signals from hardware 422. Hardware 422 may include an optional display 424, an optional input device 426 and an I/O communications device 428. I/O communications device 428 may include a network and communication circuitry for communicating with network 304, 310 or an external memory storage device.

Optional Input device 426 receives inputs from a user of the computing device 400 and may include a keyboard, mouse, track pad, microphone, audio input device, video input device, or touch screen display. Optional display device 424 may include an LED, LCD, CRT or any type of display device to enable the user to preview information being stored or processed by computing device 404.

Memory 412 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 412 of the computing device 400 may include an operating system 414, a deduplication system application 420 and a library of other applications or database 416. Operating system 414 may be used by application 420 to control hardware and various software components within computing device 400. The operating system 414 may include drivers for device 400 to communicate with I/O communications device 428. A database or library 418 may include preconfigured parameters (or set by the user before or after initial operation) such a server operating parameters, server libraries, HTML libraries, API's and configurations. An optional graphic user interface or command line interface 423 may be provided to enable application 420 to communicate with display 424.

Application 420 includes a receiver module 430, a partitioner module 432, a hash value creator module 434, determiner/comparer module 438 and a storing module 436.

The receiver module 430 includes instructions to receive one or more files via the network 304 from the remotely disposed computing device 302. The partitioner module 432 includes instructions to partition the one or more received files into one or more data objects. The hash value creator module 434 includes instructions to create one or more hash values for the one or more data objects. Exemplary algorithms to create hash values include, but is not limited to, MD2, MD4, MD5, SHA1, SHA2, SHA3, RIPEMD, WHIRLPOOL, SKEIN, Buzhash, Cyclic Redundancy Checks (CRCs), CRC32, CRC64, and Adler-32.

The determiner/comparer module 438 includes instructions to determine, in response to a receipt from a networked computing device (e.g. device hosting application 302) of one of the one or more additional files that include one or more second data objects, if the one or more second data objects are identical to one or more data objects previously stored on the one or more remotely disposed storage systems (e.g. device 312) by comparing one or more hash values for the one or more second data objects against one or more hash values stored in one or more records of the storage table.

The storing module 436 includes instructions to store the one or more data objects on one or more remotely disposed storage systems (such as remotely disposed computing device 312 using API 311) at one or more location addresses, and instructions to store in one or more records of a storage table, for each of the one or more data objects, the one or more hash values and a corresponding one or more location addresses. The storing module also includes instructions to store in one or more records of the storage table for each of the received one or more second data objects if the one or more second data objects are identical to one or more data objects previously stored on the one or more remotely disposed storage systems (e.g. device 312), the one or more hash values and a corresponding one or more location addresses of the received one or more second data objects, without storing on the one or more remotely disposed storage systems (device 312) the received one or more second data objects identical to the previously stored one or more data objects.

Illustrated in FIGS. 5 and 6, are exemplary processes 500 and 600 for deduplicating storage across a network. Such exemplary processes 500 and 600 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 5, a flowchart of process 500 executed by a deduplication application 420 (See FIG. 4) (hereafter also referred to as “application 420”) is shown. In one implementation, process 400 is executed in a computing device, such as intermediate computing device 308 (FIG. 3). Application 420, when executed by the processing devices, uses the processor 404 and modules 416-438 shown in FIG. 4.

In block 502, application 420 in computing device 308 receives one or more first files via network 304 from a remotely disposed computing device (e.g. device hosting application 302).

In block 503, application 420 divides the received first files into data objects, creates hash values for the data objects or portions thereof, and stores the hash values into a storage table in memory on intermediate computing device (e.g. an external computing device, or system 312).

In block 504, application 420 stores the one or more first files via the network 310 onto a remotely disposed storage system 312 via API 311.

In block 505, optionally an API within system 312 stores within records of the storage table disposed on system 312 the hash values and corresponding location addresses identifying a network location within system 312 where the data object is stored.

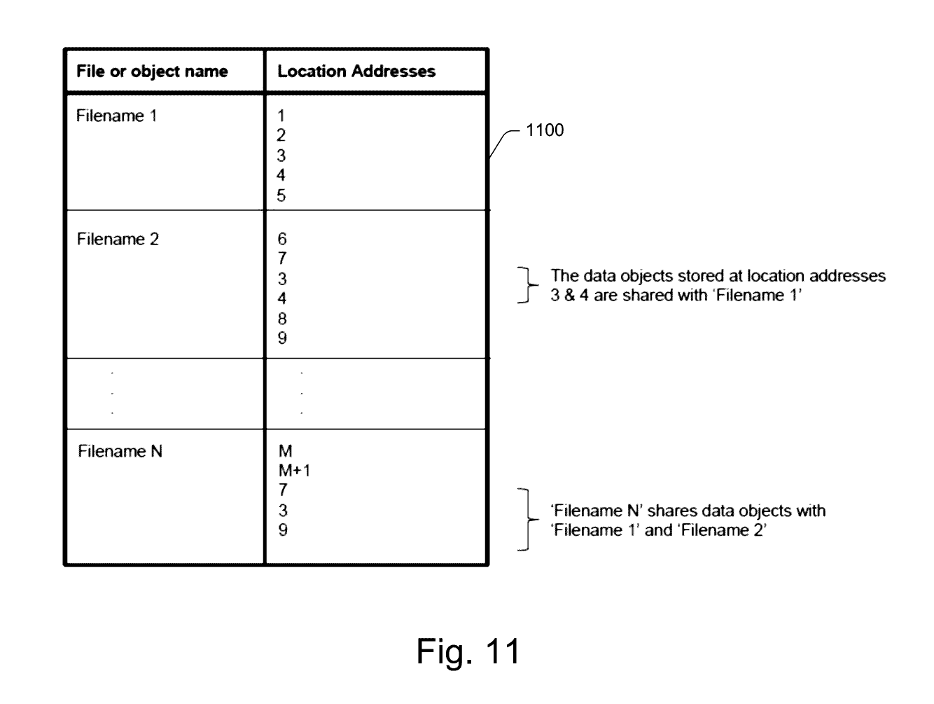

In block 518, application 420 stores in one or more records of a storage table disposed on the intermediate device 308 or a secondary remote storage system (not shown) for each of the one or more data objects the one or more hash values and a corresponding one or more network location addresses. Application 420 also stores in a file table (FIG. 11) the names of the files received at in block 502 and the location addresses created at block 505.

In one implementation, the one or more records of a storage table are stored for each of the one or more data objects the one or more hash values and a corresponding one or more location addresses of the second data object without storage of the second identical data object on the one or more remotely disposed storage systems. In another implementation, the one or more hash values are transmitted to the remotely disposed storage systems for storage with the one or more data objects. The hash value and a corresponding one or more new location addresses may be stored in the one or more records of the storage table. Also the one or more data objects may be stored on one or more remotely disposed storage systems at one or more location addresses with the one or more hash values.

In block 520, application 420 receive from the networked computing device another of the one or more files.

In block 522, in response to the receipt from a networked computing device of another of the one or more files including one or more second data objects, application 420 determine if the one or more second data objects were previously stored on one or more remotely disposed storage systems 312 by comparing one or more hash values for the second data object against one or more hash values stored in one or more records of the storage table.

In one implementation, the application 420 may deduplicate data objects previously stored on any storage system by including instructions that read one or more first files a stored on the remotely disposed storage system, divide the one or more first files into one or more first file data objects, and create one or more first file hash values for the one or more first file data objects. Once the first hash values are created, application 420 may store the one or more first file data objects on one or more remotely disposed storage systems at one or more location addresses, store in one or more records of the storage table, for each of the one or more first file data objects, the one or more first file hash values and a corresponding one or more first file location addresses, and in response to the receipt from the networked computing device of the another of the one or more files including the one or more second data objects, determine if the one or more second data objects were previously stored on one or more remotely disposed storage systems by comparing one or more hash values for the second data object against one or more first file hash values stored in one or more records of the storage table. The filenames of the second files are stored in the file table (FIG. 11) along with the location addresses of the duplicate blocks (from the first files) and the location addresses of the original blocks from the second blocks.

Referring to FIG. 6, there is shown an alternate embodiment of system architecture diagram illustrating a process 600 for storing data objects with deduplication. Process 600 may be implemented using an application 420 in intermediate computing device 308 shown in FIG. 3.

In block 602, the process includes an application (such as application 420) that receives a request to store an object (e.g., a file) from a client (e.g., the “Client System” in FIG. 1). The request typically consists of an object key (e.g., like a filename), the object data (a stream of bytes) and some metadata.

In block 604, the application splits that the stream of data into blocks, using a block splitting algorithm. In one implementation, the block splitting algorithm could generate variable length blocks like the algorithm described in the Rocksoft patent (U.S. Pat. No. 5,990,810) or, could generate fixed length blocks of a predetermined size, or could use some other algorithm that produces blocks that have a high probability of matching already stored blocks. When a block boundary is found in the data stream, a block is emitted to the next stage. The block could be almost any size.

In block 606, each block is hashed using a cryptographic hash algorithm like MD5, SHA1 or SHA2 (or one of the other algorithms previously mentioned). Preferably, the constraint is that there must be a very low probability that the hashes of different blocks are the same.

In block 608, each data block hash is looked up in a table mapping block hashes that have already been encountered to data block locations in the cloud object store (e.g. a hash_to_block_location table). If the hash is found, then that block location is recorded, the data block is discarded and block 616 is run. If the hash is not found in the table, then the data block is compressed in block 610 using a lossless text compression algorithm (e.g., algorithms described in Deflate U.S. Pat. No. 5,051,745, or LZW U.S. Pat. No. 4,558,302, the contents of which are hereby incorporated by reference).

In block 612, the data blocks are optionally aggregated into a sequence of larger aggregated data blocks to enable efficient storage. In block 614, the blocks (or aggregate blocks) are then stored into the underlying object store 618 (the “cloud object store” 312 in FIG. 3). When stored, the data blocks are ordered by naming them with monotonically increasing numbers in the object store 618.

In block 616, after the data blocks are stored in the cloud object store 618, the hash_to_block_location table is updated, adding the hash of each block and its location in the cloud object store 618.

The hash_to_block_location table (referenced here and in block 608) is stored in a database (e.g. database 620) that is in turn stored in fast, unreliable, storage directly attached to the computer receiving the request. The block location takes the form of either the number of the aggregate block stored in block 614, the offset of the block in the aggregate, and the length of the block; or, the number of the block stored in block 614.

In block 616, the list of network locations from blocks 608-614 may be stored in the object_key_to_location_list (FIG. 11) table, in fast, unreliable, storage directly attached to the computer receiving the request. Preferably the object key and block locations are stored into the cloud object store 618 using the same monotonically increasing naming scheme as the block records.

The process may then revert to block 602, in which a response is transmitted to the client device (mentioned in block 602) indicating that the data object has been stored.

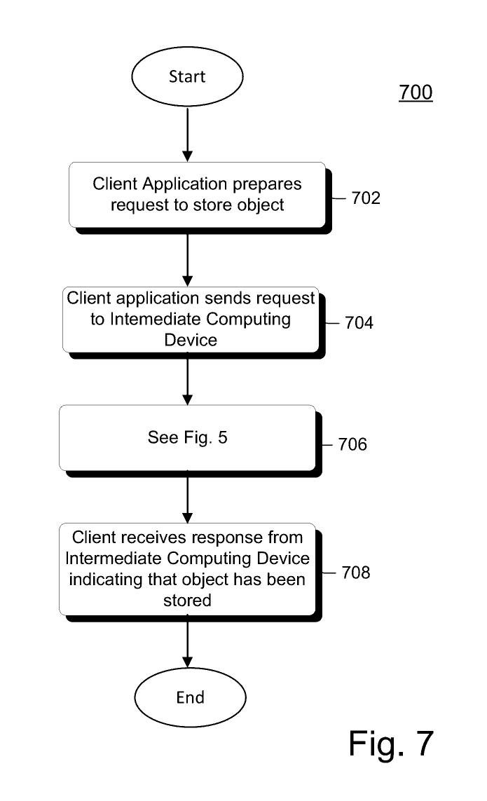

Illustrated in FIG. 7, is exemplary process 700 implemented by the client application 302 (See FIG. 3) for deduplicating storage across a network. Such exemplary process 700 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3, although it may be implemented in other system architectures.

In block 702, client application 302 prepares a request for transmission to intermediate computing device 308 to store a data object. In block 704, client application 302 transmits the data object to intermediate computing device 308 to store a data object.

In block 706, process 500 or 600 is executed by device 308 to store the data object.

In block 708, the client application receives a response notification from the intermediate computing system indicating the data object has been stored.

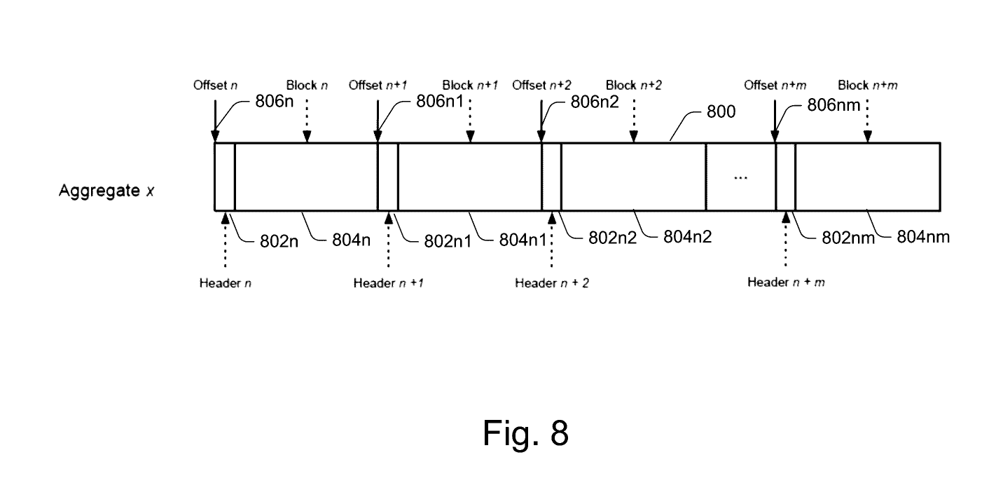

Referring to FIG. 8, an exemplary aggregate data object 800 as produced by block 612 is shown. The data object includes a header 802n-802nm, with a block number 804n-804nm and an offset indication 806n-806nm, and includes a data block.

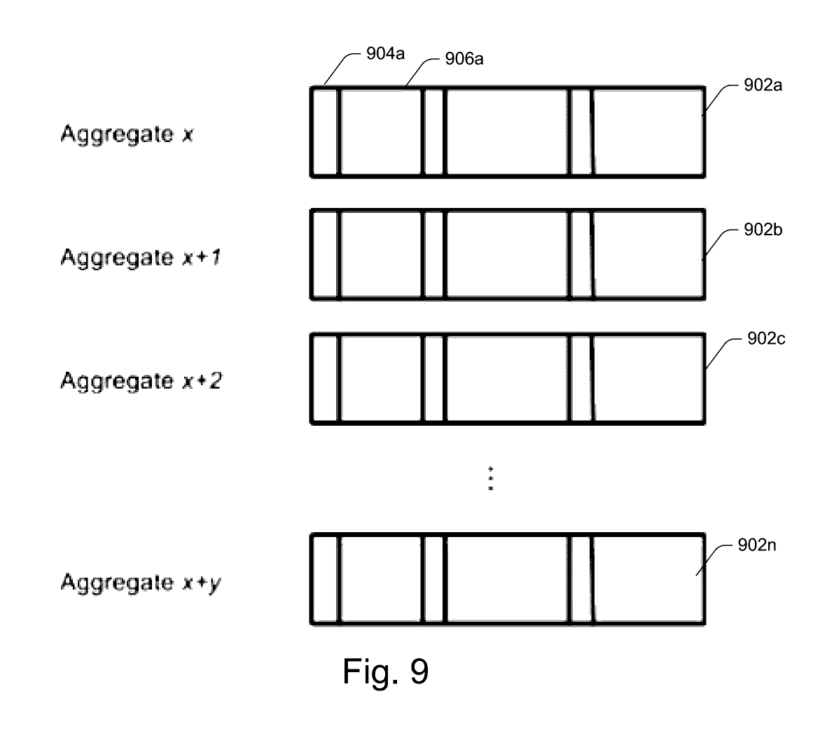

Referring to FIG. 9, an exemplary set of aggregate data objects 902a-902n for storage in memory is shown. The data objects 902a-902n each include the header (e.g. 904a) (as described in connection with FIG. 8) and a data block (e.g. 906a).

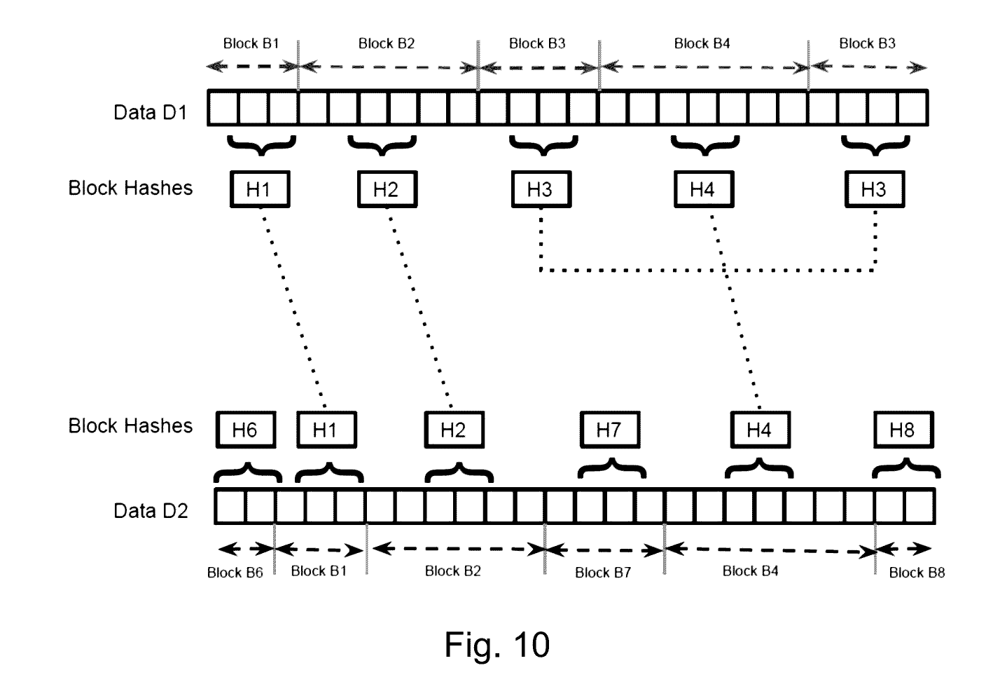

Referring to FIG. 10, an exemplary relation between the hashes (e.g. H1-H8) (which are stored in a separate deduplication table) and two separate data objects D1 and D2 are shown. Portions within blocks B1-B3 of data object (or file) D1 are shown with hashes H1-H4, and portions within blocks B1, B2, B4, B7, and B8 of data object (or file) D2 are shown with hashes H1, H2, H4, H7, and H8 respectively. It is noted that portions of data objects having the same hash value are only stored in memory once with its location of storage within memory recorded in the deduplication table along with the hash value.

Referring to FIG. 11, a table 1100 is shown with filenames (“Filename 1”-“Filename N”) of the second files stored in the file table along with the network location addresses 1-5 of the duplicate blocks (from the first files) and the network location addresses 3-4, 6-9 of the original blocks from the second blocks. In one implementation, the data objects of “Filename 2” are stored at location address 3 and 4 are shared with “Filename 1”. In another implementation, “Filename N” shares data objects with “Filename 1” and “Filename 2”.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method to deduplicate file storage in a file storage system via a network, the method comprising:
executing with a processor a first set of instructions stored in a memory device, the first set of instructions when executed by the processor:
receive one or more first files via the network from the remotely disposed computing device;
divide the one or more first files into one or more data objects;
create one or more hash values for the one or more data objects;
store the one or more data objects on one or more remotely disposed storage systems at one or more location addresses;
store in one or more records of a storage table disposed on the intermediate device or a secondary remote storage system for each of the one or more data objects the one or more hash values and the one or more location addresses where the one or more data objects are stored;
receive from the networked computing device via the network one or more second files; and
in response to the receipt via the network from the networked computing device of the one or more second files including one or more second data objects, determine whether or not the one or more second data objects were previously stored on one or more remotely disposed storage systems by comparing one or more hash values for the one or more second data objects against the one or more hash values stored in one or more records of the storage table, and
storing via the network one or more second data objects, not previously stored on the one or more remotely disposed storage system, on the one or more remotely disposed storage systems in response to a determination that the comparing of one or more hash values for the second data object against the one or more hash values for the first data object and stored in one or more records of the storage table failed to indicate a match.

2. The method to deduplicate file storage in a file storage system via a network as recited in claim 1, wherein the set of instructions when executed by the processor includes:
in response to a comparison of the has value for the first data objects and the second data object, storing in one or more records of a storage table for each of the one or more first files and second files and one or more location addresses of the data object of the first files without storage of a second identical data object of the one or more second files on the one or more remotely disposed storage systems.

3. The method to deduplicate file storage in a file storage system via a network as recited in claim 1, wherein the set of instructions when executed by the processor includes:
transmitting the one or more hash values to the remotely disposed storage systems via the network for storage with a location indication of one or more first data objects.

4. The method to deduplicate file storage in a file storage system via a network as recited in claim 1 further comprising:
storing via a network a hash value for a data object and a corresponding location address for the data object in the one or more records of the storage table.

5. The method to deduplicate file storage in a file storage system as recited in claim 1 further comprising:
replacing a first network address or a first network name of one of the remotely disposed storage systems with a second network address or a second network name of another of the remotely disposed storage systems so that data objects are automatically stored on the another of the one or more remotely disposed storage systems.

6. The method to deduplicate file storage in a file storage system as recited claim 1, wherein executing with a processor a set of instructions when executed by the processor further comprises:
read one or more first files a stored on the remotely disposed storage system;
divide the one or more first files into one or more first file data objects;
create one or more first file hash values for the one or more first file data objects;
store the one or more first file data objects on one or more remotely disposed storage systems at one or more location addresses;
store in one or more records of the storage table, for each of the one or more first file data objects, the one or more first file hash values and a corresponding one or more first file location addresses; and
in response to the receipt from the networked computing device of the another of the one or more files including the one or more second data objects, determine if the one or more second data objects were previously stored on one or more remotely disposed storage systems by comparing one or more hash values for the second data object against one or more first file hash values stored in one or more records of the storage table.

7. The method to deduplicate file storage in a file storage system as recited claim 1, wherein the one or more location addresses for the one or more data objects for the first file is stored on one or more remotely disposed storage systems with the one or more hash values.

8. The method to deduplicate file storage in a file storage system as recited in claim 1, wherein executing with the processor the set of instructions when executed by the processor further comprises:
receive one or more first files via a network from a remotely disposed computing device;
store the one or more first files via the network on a remotely disposed storage system; and
replace storage operations of the first set of instructions stored in the memory device of the intermediate computing system with a second set of instructions.

9. The method to deduplicate file storage in a file storage system as recited in claim 1, wherein storing in one or more records of a storage table disposed on the intermediate device or a secondary remote storage system for each of the one or more data objects the one or more hash values and a corresponding one or more location addresses further comprises:
store in the store table a plurality of file names for the first files, with the hash values and the corresponding one or more location addresses for each of the plurality of file names, wherein the one or more location addresses corresponding to one of the plurality of filenames is included in the file table with one or more location address for a second one of the plurality of filenames.

10. The method to deduplicate file storage in a file storage system as recited in claim 9, further comprising:
store in one or more records of the storage table, for one of the one or more first file data objects, a file name of the one of the one or more first file data objects and one or more first file location addresses of the one or more first file data objects, the one or more first file location addresses determined in response to comparing the one or more first file hash values to one or more hash values determined by computing a hash value for one of the one or more first data objects, and
store in one or more records of the storage table, for one or more second file data objects, a file name of one of the second file data objects and one or more second file location addresses of the one or more second file data objects, wherein at least one of the second file locations address of one of the second file data objects is the same as one of the one of the first file location addresses of one of the first file data objects.

11. An intermediate processing device to reduce duplication of the storage of one or more files comprising:
circuitry to receive one or more files via a network from a remotely disposed computing device;
circuitry to partition the one or more received files into one or more data objects;
circuitry to create one or more hash values for the one or more data objects;
circuitry to store the one or more data objects on one or more remotely disposed storage systems at one or more location addresses;
circuitry to store in one or more records of a first storage table, for each of the one or more data objects, the one or more hash values and a corresponding one or more location addresses;
circuitry to store in one or more records of a second storage table, a file name for at least one of the received files and the one or more location addresses where the one or more data objects that are included in one of the received files are stored;
circuitry to determine, in response to a receipt from a networked computing device of one of the one or more additional files that include one or more second data objects, if the one or more second data objects are identical to one or more data objects previously stored on the one or more remotely disposed storage systems by comparing one or more hash values for the one or more second data objects against one or more hash values stored in one or more records of the storage table; and
circuitry to store in one or more records of a storage table for each of the received one or more second data objects if the one or more second data objects are identical to one or more data objects previously stored on the one or more remotely disposed storage systems, the one or more hash values and a corresponding one or more location addresses of the received one or more second data objects, without storing on the one or more remotely disposed storage systems the received one or more second data objects identical to the previously stored one or more data objects.

12. The intermediate processing device to reduce duplication of the storage of one or more files as recited in claim 11, further comprising:
circuitry to store in one or more records of the second storage table, an additional file name for at least one of the received additional files and the one or more location addresses where the one or more data objects that are included in the at least one additional received file are stored, wherein at least one of the one or more location addresses where the one or more data objects that are included in the at least one additional received file are stored matches the one or more location addresses where the one or more data objects that are included in the one of the received files are stored.

13. The intermediate processing device to reduce duplication of the storage of one or more files as recited in claim 11, wherein the location address are network addresses.

14. The intermediate processing device to reduce duplication of the storage of one or more files as recited claim 11, wherein the one or more location addresses for the one or more data objects for the first file is stored via a network on one or more remotely disposed storage systems with the one or more hash values.

15. A computer readable storage medium comprising instructions which when executed by a processor comprises:
instructions to receive one or more files via a network from a remotely disposed computing device;
instructions to partition the one or more received files into one or more data objects;
instructions to create one or more hash values for the one or more data objects;
instructions to store the one or more data objects on one or more remotely disposed storage systems at one or more location addresses;
instructions to store in one or more records of a storage table, for each of the one or more data objects, the one or more hash values and a corresponding one or more location addresses;
instructions to store in one or more records of a second storage table, a file name for at least one of the received files and the one or more location addresses where the one or more data objects that are included in one of the received files are stored;
instructions to determine, in response to a receipt from a networked computing device of one of the one or more additional files that include one or more second data objects, if the one or more second data objects are identical to one or more data objects previously stored on the one or more remotely disposed storage systems by comparing one or more hash values for the one or more second data objects against one or more hash values stored in one or more records of the storage table;
instructions to store in one or more records of a storage table for each of the received one or more second data objects if the one or more second data objects are identical to one or more data objects previously stored on the one or more remotely disposed storage systems, the one or more hash values and a corresponding one or more location addresses of the received one or more second data objects, without storing on the one or more remotely disposed storage systems the received one or more second data objects identical to the previously stored one or more data objects; and
instructions to store in one or more records of the second storage table, an additional file name for at least one of the received additional files and the one or more location addresses where the one or more data objects that are included in the at least one additional received file are stored, wherein at least one of the one or more location addresses where at least one of the one or more data objects that are included in the at least one additional received file are stored matches at least one of the one or more location addresses where the one or more data objects that are included in the one of the received files are stored.

16. The computer readable storage medium comprising instructions as recited in claim 15, wherein the location addresses are internet or web based network addresses.
